(19) United States
(12) Patent Application Publication
(10) Pub. No.: US 2011/0260869 A1
(43) Pub. Date: Oct. 27, 2011

(54) Method And Device For Tracing Objects And Detecting Change In Configuration Of Objects

(75) Inventors: Andre Gagnon, Gatineau (CA); Rene Schmidt, Ottawa (CA)

(73) Assignee: TEKTRAP SYSTEMS, INC., Gatineau, QC (CA)

(21) Appl. No.: 13/122,678

(22) PCT Filed: Oct. 6, 2009
(86) PCT No.: PCT/CA2009/001401

§ 371 Date: Jun. 20, 2011

Related U.S. Application Data
(60) Provisional application No. 61/103,018, filed on Oct. 6, 2008.

(51) Int. Cl. G08B 13/14

(52) U.S. Cl. 340/572.1

(57) ABSTRACT

A change in the configuration of an object is detected by an antenna from at least a portion of the object or providing an antenna closely electrically coupled to said object, receiving remote radio transmissions with a radio receiver using said antenna, and detecting a change in the configuration of said object by monitoring the signal strength of the radio transmissions received from the antenna. The same antenna can also be used to determine the path traced by the object by receiving the remote radio transmissions and comparing them with known spectra.

### CROSS REFERENCE TO RELATED APPLICATION

This application claims the benefit under 35 USC 119(e) of U.S. provisional application No. 61/103,018, filed Oct. 6, 2008.

### FIELD OF THE INVENTION

This invention relates to a system for tracing of objects and detecting a change in the configuration of objects, such as containers, and in particular to a system for detecting an intrusion event of such container, and in particular to a system for detecting a door-opening event of such containers.

### BACKGROUND OF THE INVENTION

There are approximately 7 million maritime style containers that enter and leave Canada per year, and likewise 70 million for the USA. The interiors of such containers are rarely inspected; 3% before 11 Sep. 2001 and 5% today. With market globalization, a large amount of these containers enter North America on a daily basis. Such containers may include contraband or dangerous items that present an economic, political or security risk. Despite significant security improvements, only 5% of the maritime containers that arrive in or transition through North America go through a physical inspection.

Current container tracking technologies based on GPS consume high DC power, are costly, require line-of-sight with satellites, and they are often too large to be covert. U.S. Pat. No. 7,551,137, the contents of which are incorporated by reference, describes a tracing system based on an FM broadcast signal. This is an alternative man-made signal that is reasonably ubiquitous, provides a geographically unique frequency spectrum, and is about 100,000 times as strong as a GPS satellite signal. This allows the development of a low cost, low power and miniature FM receiver that can record frequency spectrums and compare them to known data in order to trace the path that the container has taken for less than 10$ per container.

U.S. Pat. No. 4,023,179 describes a camouflaged military antenna formed from the slot created when the door of a pick-up truck having a metal shelter is left partially ajar.

### SUMMARY OF THE INVENTION

According to the present invention there is provided a method of detecting a change in the configuration of an object, comprising forming an antenna from at least a portion of said object or providing an antenna closely electrically coupled to said object; receiving remote radio transmissions with a radio receiver using said antenna; and detecting a change in the configuration of said object by monitoring the signal strength of the radio transmissions received from said antenna.

The method can be implemented in a concealed device generally referred to herein as an “FM tag”. Thus, in accordance with one aspect of the invention, the body of the object, for example, a shipping container or other metallic structure is used as a covert antenna for FM spectrum monitoring with the aid of the FM tag. In particular, the slot formed between the container doors may form a slotted antenna. In this case, opening the container doors will result in a change in reception characteristics that can be used to detect the event.

As an added security benefit, the FM tag is also capable of detecting the time and location of a security event, such as when a container door is opened.

In an alternative embodiment, the object can conveniently be a vehicle, such as a car or truck. In this case, a slot formed by the trunk or hood and the rest of the body can form the slotted antenna. In this case, it is possible to detect an opening or closing of the hood or trunk.

A change-in-configuration event may be correlated with a signal trilateration technique, such as the method described in the co-pending application referred to above, to determine the position of the object at the time of the event. Unlike triangulation, which is a process of determining the location of a point by measuring angles to it from known points at either end, trilateration is a method of determining the relative positions of objects using the geometry of triangles in a similar fashion as triangulation. Unlike triangulation, which uses angle measurements (together with at least one known distance) to calculate the subject's location, trilateration uses the known locations of two or more reference points, and the measured distance between the subject and each reference point. In an embodiment of the invention, the distance between the subject and the reference points are calculated using RSSI (Received Signal Strength Indication), and the known location of each reference point is used to calculate where the FM tag is relative to the reference points.

Alternatively, a correlation technique may be employed wherein the detected radio frequency spectrum is correlated with a database of known spectra, possibly taking time into account, to identify the location of the device.

When the object is a shipping container, or other object with a door closure, a change-in-configuration may correspond to a door opening or closing event. In this case the body of the container may form the antenna, and the gap between the doors forms a slot such that the whole configuration corresponds to a slotted antenna.

When the object is a vehicle, or other object with a license plate, the gap or space between the license plate and the vehicle may form the antenna such that the whole configuration corresponds to a patch antenna. In this case, the FM tag can conveniently be covertly inserted between the license plate and the car.

In yet another embodiment, advantage may be taken of the fact that a metallic shipping container will act as a Faraday cage, so that the signal strength within a completely closed container will be zero. However, any opening within the floor, walls or roof of the container will allow RF energy to leak inside. For example, if a person removes a wall panel and climbs into the container, the amount of RF energy within the container will increase, and this effect can be used as the basis for an intrusion detector. A sudden increase in RF signal strength from external broadcast transmitters would indicate that the integrity of the container has been breached.

As in the case of our U.S. Pat. No. 7,551,137 referred to above, the source of RF energy may conveniently be a commercial FM broadcast station, although it will be appreciated that other sources, such as cellular phones, etc. can be employed.

A motion sensor, such as a 3D accelerometer, may be incorporated into the FM tag to identify different types of motion such as a lack of motion, truck motion, train motion, ship motion and airplane motion.

The motion sensor can also used to detect container shook/vibration during transit and handling. When a specific vibration level has been exceeded (e.g. 6 g), the location and 3D vibration pattern is recorded and may be retrieved later to assist insurance companies in identifying the location of the event in the case where goods have been damaged.

The motion sensor is also a key element for reducing the FM tag's power consumption by limiting recording to when the FM tag is in motion. The FM tag can remain in low-power mode during which it only monitors and detects motion. High-power recording is therefore only performed if sufficient motion is detected.

The motion sensor, being in the FM tag that is mounted in the door gasket, may be used to detect the opening and closing of the door. The FM tag includes a covert RF transceiver to communicate to other transceivers.

The transceiver may also be installed inside the door gasket and therefore also be covert. The transceiver radiates both inside and outside the container, which allows it to communicate with a second FM tag mounted inside the container positioned in such a way as to monitor and detect intrusion via the side panel, floor or ceiling.

The transceiver can be networked so as to link multiple FM tags together to relay and share network location and status information.

In one embodiment, the FM tag remains mostly in low-power mode to save battery life. All components except for the accelerometer are turned off in this mode. An external RF source is used to “wake-up” the FM tag from the low power mode so that it can transmit its status. When distance between the fixed high-power transceiver is shorter, say within 10 m, the said fixed high-power transceiver can be used to temporally power the FM tag, especially to cover the incremental power needed when the FM tag's transceiver circuit 6 is on to transmit its status 2b.

A fixed high-power transceiver, positioned along the path, say within 50 m, serves as an RF source to wake up the FM tag and to read the FM tag status.

The invention can also be used in conjunction with a satellite-based navigation system, such as GPS. If a GPS receiver is provided in the object, such as a shipping container, this can be used when GPS signals are available to improve positional accuracy. One system uses a hybrid GPS/FM approach where the relative contribution of the GPS signals to the positional fixes allowing the path tracing depends on the power availability and/or signal strength. The GPS can also be used to provide accurate timing information and to provide course positional information to improve the accuracy of the FM trilateration algorithms. The GPS can also provide an initial reference point on start up so that the system has an accurate starting point from which to deduce the path traced by the object even if the GPS signals are subsequently lost, for example, as a result of the doors being closed.

The GPS and FM monitoring system can also be applied using a peer-to-peer approach, wherein objects that are located in close proximity, such as in a train, are arranged to form a wireless network, and wherein the objects exchange data, such as positional information, to improve accuracy. For example, in this environment, some objects may get a better fix than others, and by exchanging information they can improve the overall accuracy of the system.

The hybrid GPS/radio transmission monitoring system or method can be used in conjunction with the slotted antenna or independently thereof.

### BRIEF DESCRIPTION OF THE DRAWINGS

The invention will now be described in more detail, by way of example only, with reference to the accompanying drawings, in which:

FIG. 1 is a block diagram of the FM tag.

FIG. 2 is a cross section of a shipping container door showing the location of an FM tag;

FIG. 3 shows the radiation pattern for a door slot antenna on ground at 98 MHz, total polarization plot, for a 20 ft container, but which is also valid for a 40 ft container or 52 ft container;

FIG. 4 shows the two-dimensional radiation pattern for a door slot antenna on ground, at 98 MHz, for a 20 ft antenna;

FIG. 5 shows the FM spectra of the closed and opened door using a spectrum analyzer;

FIG. 6 shows the experimental results obtained from a journey between Montreal and New York using a different correlation algorithm;

FIG. 7 shows the experimental results obtained from a journey between Montreal and New York using a different correlation algorithm.

FIG. 8 shows the system diagram of multiple tagged containers in transit.

FIG. 9 shows the system diagram of multiple tagged containers in a storage yard.

FIG. 10 is a flow chart illustrating operation of the microprocessor.

### DETAILED DESCRIPTION OF THE PREFERRED EMBODIMENTS

In FIG. 1, the FM tag comprises an RF front end 3, connected to an antenna 1 and a microprocessor 5. The microprocessor is also connected to wake-up unit 4 connected to antenna 2a and transceiver 6 connected to antenna 2b, which may be grouped together as a common antenna. The transceiver 6 may suitably be a wireless chip sold under the designation MRF24J40MA by Microchip. The antennas 2a and/or 2b can be concealed in a door gasket, for example, of a shipping container. The microprocessor may be a PCI24FJ256G device from Microchip. This comes with a built in sleep mode. The microprocessor can be woken from the sleep mode by applying a suitable input signal.

A 3D accelerometer 7 is connected to the wake-up unit 4 and microprocessor 5. An exemplary accelerometer is ADXL345 by Analog Devices. The 3D accelerator can activate the wake-up unit 4 when motion is detected. In this way, the FM tag can be placed in a low power sleep mode when the unit is not in motion, and only activated when motion is detected.

Also, the vibration pattern can be stored in memory 12 for future use in the event of an insurance claim since it will indicate the magnitude and type of shock to which a container may have been subjected.

GPS unit 10 is also connected to the microprocessor along with energy management unit 8, which in turn is connected to the battery 11 and energy storage unit 9.

Memory 12, which can suitably be an SD card, is used to store data including trace and positional information.

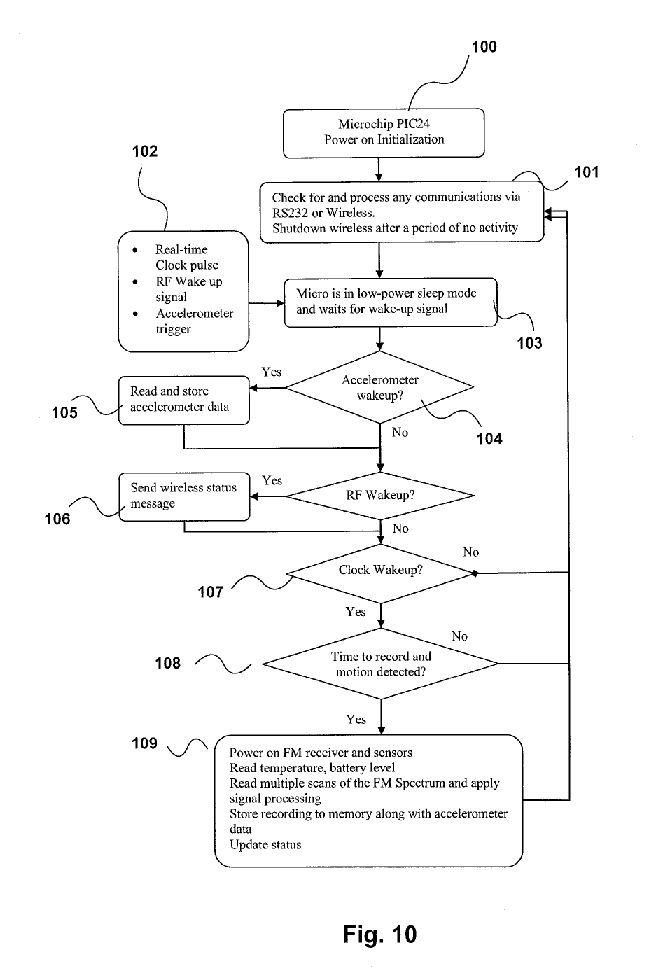

The operation of the microprocessor will be described with reference to FIG. 10. The microprocessor is initialized at step 100. At step 101, a check is made for any wireless communication. In the absence of communication, the microprocessor is placed in the sleep mode.

In state 103, the microprocessor waits for a wake-up signal, which may come from a clock, an external transmitter providing an RF signal, or the accelerometer as shown by block 102.

In the event of an accelerometer wake-up (step 104), the accelerometer data is read and the data stored in memory 12.

In the event of and RF wake-up signal, a wireless status message is sent to the external transceiver (step 106).

In the event of a clock wake-up signal (step 107), a check (step 108) is made to see whether any motion is detected and whether it is time to record observations.

In the event the answer is yes, various actions are taken at step 109. The FM receiver and sensors are powered on. The temperature and battery level are read. Multiple scans are made of the FM spectrum and these are subjected to signal processing to determine location. The results are stored in memory 12 along with any accelerometer data.

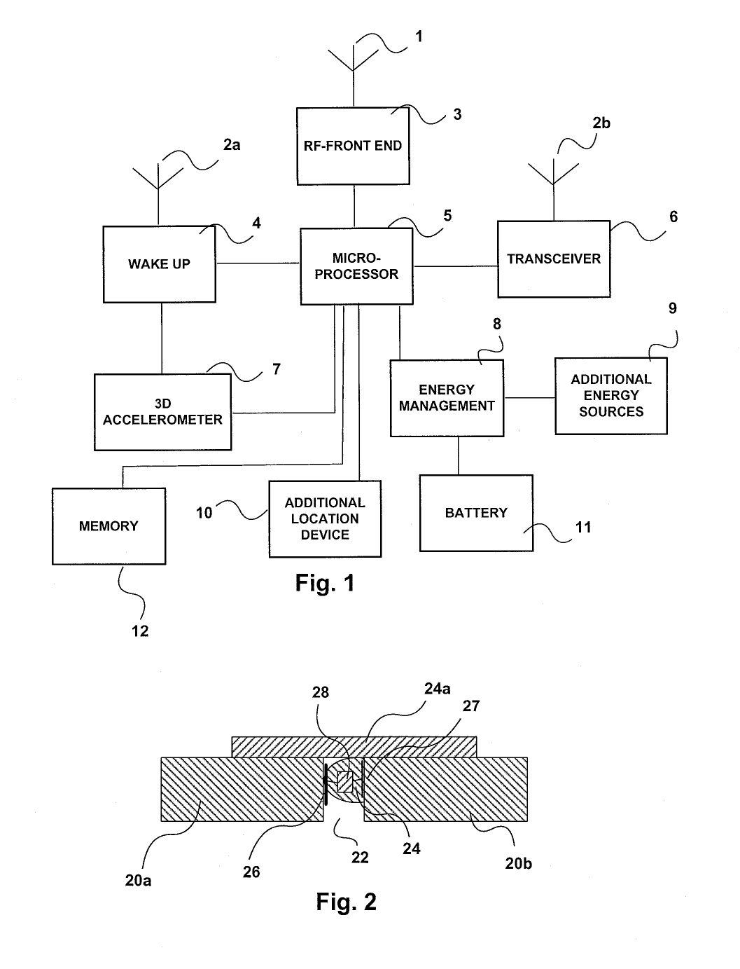

The physical configuration is shown in FIG. 2. The two closed panels 20a, 20b of a shipping container door define between them a slot 22 in which is located a seal 24. The FM tag 28, which may be generally of the type described in U.S. Pat. No. 7,551,137 referred to above, is located inside the seal 24.

The FM tag 28 is coupled to the left door 20a through a capacitive coupling strip 26 to a make/break contact. The FM tag is also coupled to the right door 20b through a coupling strip 27, which may either be a direct contact or a capacitive contact. This arrangement allows the gap, typically about ½″ wide (about 2¼ cms) between the closed doors to form a slot antenna, which serves as the antenna for the FM location services when the object is in motion. It will be appreciated by persons skilled in the art that a slot antenna consists of a metal surface, usually a flat plate, with a hole or slot cut out. When the plate is driven as an antenna by a driving frequency, the slot radiates electromagnetic waves in similar way to a dipole antenna.

The FM tag 28 may conveniently be located in the rubber section between the edge of the door and the container body part, on the hinges side of the door. This makes the FM tag more covert as when the door is open, for some rubber strips, one can see the FM tag insert in the rubber. When the FM tag is inserted in the rubber strip on the side, it may still be possible to see it, but one need to specifically look for it, whereas when the FM tag is inserted between the two doors, it is unlikely to be found by accident without being specifically looked for.

The advantage of such architecture is that it provides maximum signal strength reception when the doors are closed and minimum when the doors are open. This is exactly what the FM tag needs to capture FM spectrum data while the container is closed during transit.

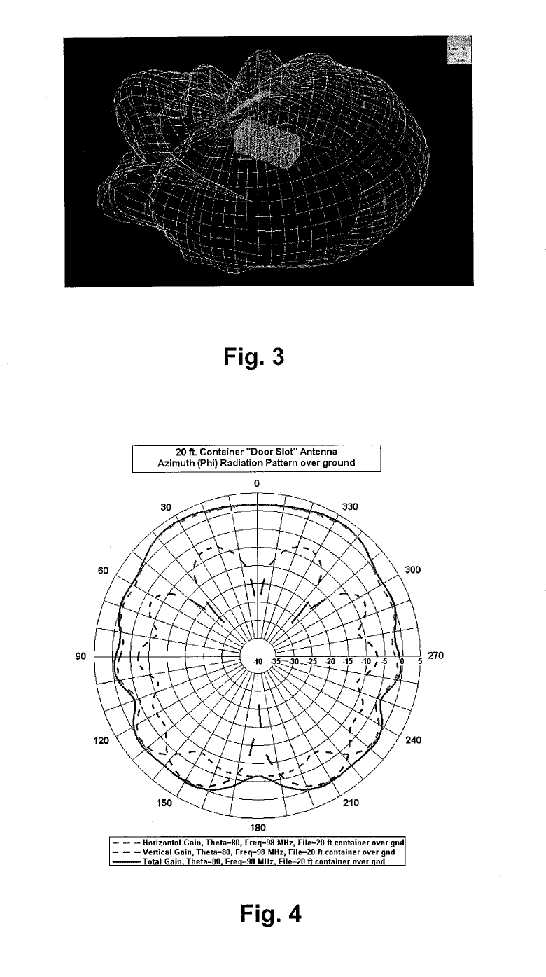

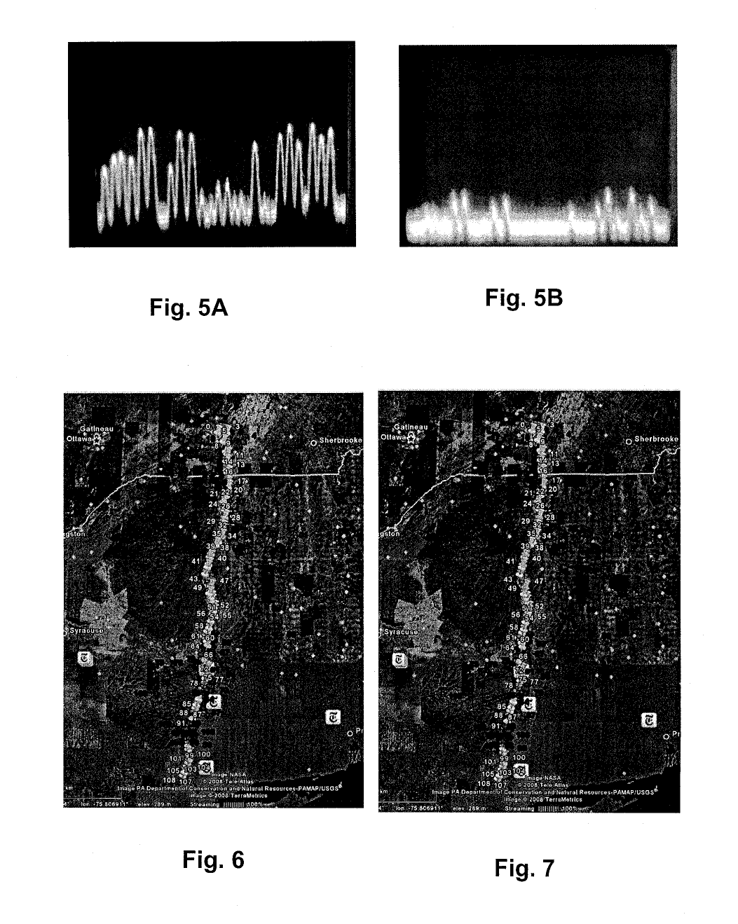

Simulated Radiation Pattern, shown in FIGS. 3 and 4, indicates that the signal strength received by the container in this configuration is equivalent to the signal received by a ¼ wave whip antenna. FIG. 5a versus 5b show the close versus open FM spectrum respectively that show a closed-to-open ratio that averages 30 dB on the X scale: 2 MHz/div centered at 98 MHz, Y scale: 10 dB/div.

In particular, testing of the slot antenna on a container facing a commercial broadcast FM transmitter at Camp Fortune near Ottawa showed a signature averaging from 30 to 35 dB between the open and closed states of the door. In addition, the signal remained 35 dB less even when the door was ½ inch open and the absolute signal strength only drops 5 to 10 dB when the container door faced the opposite direction in reference to the FM transmitter located at Camp Fortune. Further testing on a variety of containers with different door and slot designs indicated that the concept of using the slot as a receiving antenna for the FM tag is applicable over a range of containers and test conditions.

Adequate signal levels were recorded in three containers of differing door construction under adverse weather conditions. It was estimated that the slot or “door gap” antenna could provide adequate reception up to 200 km from transmitters similar to those at Camp Fortune, Gatineau, Quebec.

Tests also revealed that the recorded levels are surprisingly insensitive to the door gap geometry, which indicates that this could be a universal solution for FM reception within the container. The door coupling mechanism 26 and 27 is constructed so as to ensure that it is compatible for a range of container door geometries, and to deal with the harsh environments likely to be encountered.

Using the metal enclosure of the container as the antenna, tests on stacked containers in Montreal storage yard showed that the concept of detecting container door openings using an FM receiver works well and is even better when the containers are stacked. The container on top of the stack receives the FM signal, which then couples the FM signal toward the ground using a ground return concept. Any containers between the top and the ground receive the FM signals. It is believed that the signal received by the lowest container is indeed the signal picked up by the higher container (since signal strength increases with elevation), which is passed to the lower container by direct conductivity between containers. The residual signal picked up with the door open is even lower, which shows that the signal in the air around the lower container is lower due to the confined space in the storage yard. Tests on horizontal polarization (FM tag position on the upper horizontal part of the container side wall) showed that the signal is around 8 dB weaker than with vertical polarization (FM tag position on middle vertical part of the door seal).

Two prototypes were built and used for determining the path resolution of a detection system using the doors as the basis of a slotted antenna. The prototypes were based on a TI micro-controller, which interfaced to a USB Wiz board that interfaced to a Silicon Labs USB FM reference receiver, a USB Prolific GPS device and an SD card for storage.

Tests were then performed to determine the accuracy of the position information using the container as an antenna. The proposed location algorithm relied on a combination of the relative uniqueness of a spectrum, a 3rd party transmitter database recording signal strengths, frequencies and locations of commercial broadcast transmitters, the occasional digital information from RDS/RDBS-based signals, trilateration concepts and relative signal strengths to calculate the most probable location of a receiver. Generally, the position-finding technique was the same as described in U.S. Pat. No. 7,551,137, the contents of which are incorporated by reference.

The initial algorithm relied on RDS/RDBS information in order to create a reference point from which to select the most likely FM transmitters to be used in the trilateration calculations as described in U.S. Pat. No. 7,551,137. Assuming that a container could be transported at 100 km/hr, it was predicted that the FM spectrum would need to be scanned within 1/100th of an hour to achieve 1 km accuracy. Experimentally, the unfortunate side effect of such a short scanning period was discovered and resulted in incomplete or missing RDS/RDBS data.

As an alternative to using the RDS/RDBS data, it was predicted that the FM frequency spectrum of a city is sufficiently unique to form a starting reference point. Assuming a maximum speed of approximately 100 km/hr, the adjacent receiver locations could be predicted thereby allowing a relative trace to be calculated with each point along the path calculated using relative trilateration calculations and forming the reference point for the next point.

Experimentation with trilateration and correlation techniques showed that it is possible to identify an FM tag's location to within 10 km using trilateration and to within 1 km using correlation techniques at least 25% of the time. The results showed that a good portion of the error was due to a poor signal to noise ratio due to un-optimized hardware and signal processing techniques. To overcome these obstacles, the FM tag was redesigned to use a proprietary receiver, which offers better control and lower power consumption for improved signal processing. This version of the FM tag will provide better SNR with less multipath noise. Techniques to improve correlation techniques require a combination of public and proprietary RSSI databases which are in development.

The accuracy of the location algorithm was determined to be dependent on a high SNR, low multipath and special techniques to remove unwanted signals when correlating empirical RSSI data with publicly available theoretical RSSI data from governmental agencies.

These tests also show that a slot or “door gap” antenna can provide as much as 30 dB signal-to-noise ratio when acting as a VHF antenna for a tracing device. We estimate a reception of up to 200 km from commercial FM transmitters.

We have shown that signals received by the lowest of several stacked containers is the signal picked up by the highest container (since signal strength increases with elevation) which is passed to the lower container by direct conductivity between containers. The result is a covert low-cost technique that captures the FM spectrum, detects door opening/closing status, extracts motion status and communicates its status to the outside in a networkable architecture

Based on initial tests, it is believed that the corridor map correlation technique is approximately 10 times more accurate than the trialateration technique (which uses multiple transmitter signal strengths to calculate location).

Depending on the quality of the signal, we are able to pinpoint a location to within 1 km (+/−500 m) between 20% to 70% of the time. We have also shown that various types of recorded-data filtering can improve results.

Multi-path may be reduced by using a spatial diversity technique (two or more time consecutive sampling points for a container in motion). In a test between Montreal and New York, as shown in FIGS. 6 and 7, using a trilateration algorithm, 25% of points lay within 10 km.

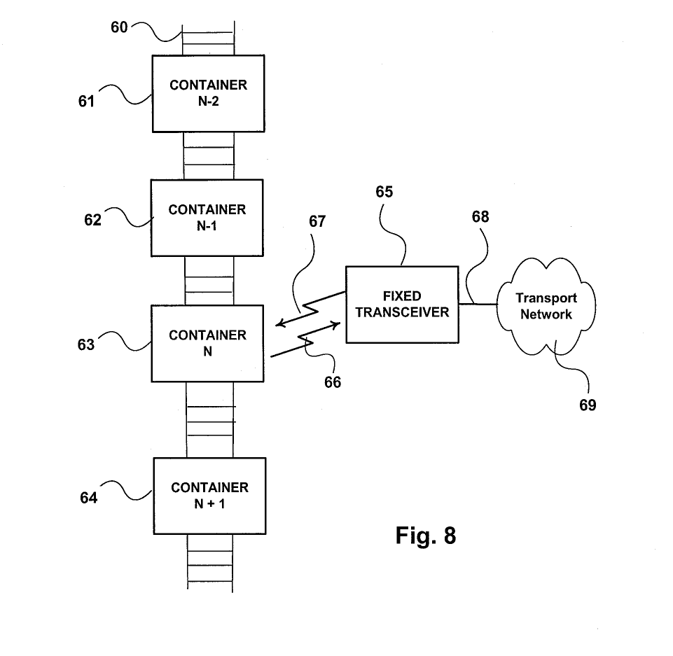

FIG. 8 shows a series of containers forming part of a train. The FM tag on each of the containers 61 to 64 is responsive to a wake-up signal 66 transmitted from the fixed transceivers 65 located at strategic points along the side of the railway track 60 using covert antennas 2a. This signal is received by wake-up unit 4 using antenna 2a. In response to a wake-up signal, the FM tag enters the active state and transmits its stored data using transceiver 6 and antenna 2b, including recorded positions over link 67 as it passes the fixed transceivers 65. The data received by the fixed transceivers 65 can then be transmitted over link 68 to public transport network 69, such as the Internet, which can allow the data to be retrieved at a central monitoring station.

In addition, the signal emitted by the FM tag includes a unique container international identification number providing the FM tag with an additional source of reference for the authorities.

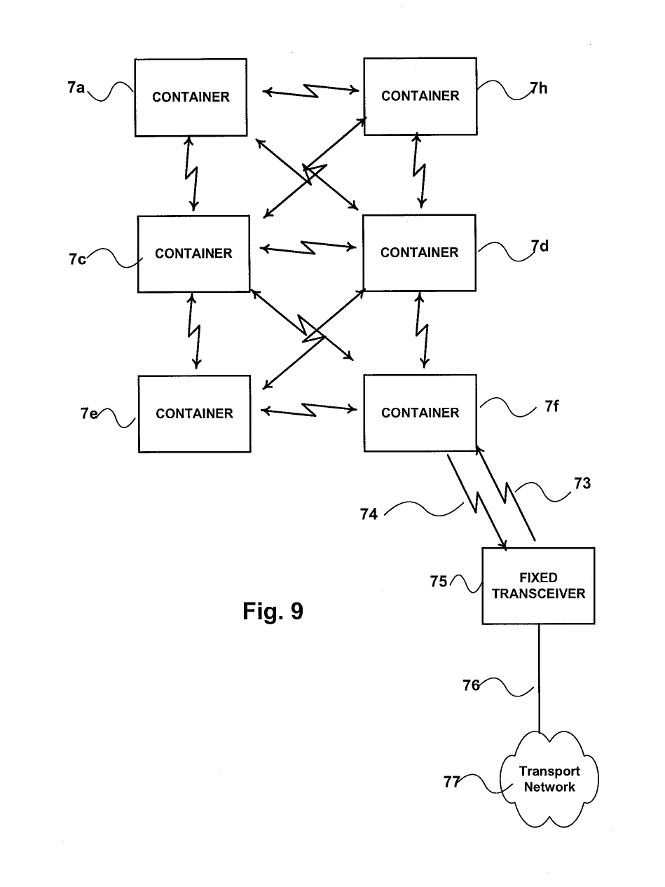

The FM tags in a series of containers can be arranged into a network as shown in FIG. 9. Containers 71a . . . 71f each contain an FM tag of the type described. The containers each contain a transceiver that communicates with other containers in the network to exchange status information. The physically closest container 71f is woken-up by link 73. The physically closest container 71f of the network 71a . . . 71f then communicates over wireless links 74 with a fixed transceiver 75 communicating over link 76 with network 77.

In another preferred embodiment, the FM tag is outfitted with a GPS device creating a hybrid device based on the best of both location detection techniques. In this embodiment, a device uses a low-power optimized monitoring algorithm for retrieving location information from both the FM signals and the GPS signals. Coarse location information provided by the lower-power FM receiver is used to “warm-start” a GPS device thereby reducing the time and hence power to obtain a GPS fix. By keeping the GPS monitoring duty cycle optimized, course location information can provide GIS reference points and absolute time along a trace. The monitoring algorithm can be adjusted to favor either the FM or GPS signals in order to provide variable functionality proportional to available power. For example, when combined with the RF transceiver component, a device with an additional power supply may be outfitted with a GPS and thereby relay GIS information to neighboring devices that are part of the same network. In this context, only one of the devices needs to have good GPS satellite reception and a larger power supply than usual.

A further application of the invention is in the monitoring of vehicles by the authorities, such as police or border agencies. For example, the authorities may wish to compare the route actually traveled by a driver with the route he claims to have traveled. In this case, they can fit an FM tag to the vehicle, using the vehicle body as the antenna, and record a series of locations of the vehicle determined by the FM trilateration technique. Privacy legislation and concerns may restrict the location of the FM tag to the license plate, assuming that the license plate is government property. The gap between the license plate and the vehicle provides a coupling mechanism needed to allow the vehicle to behave as an antenna. The locations of the FM tag can be stored in memory in the device at the time of specific events triggered by other sensors or at preset or random times. For example, in the case of a vehicle entering a country, border authorities may wish to attach an FM tag to a license plate as the vehicle enters the country. Upon departure, the authorities can extract the stored data using short range RF (without physically accessing the FM tag) and compare it to the account offered by the driver to assist them in identifying drivers who are not being truthful about their whereabouts and may have illicit motives.

The FM tag may be positioned between the license plate and the car. As most plates are made of aluminum and car bumpers are now generally made of plastic, it may be impossible to use a magnet, which would be most convenient. One solution is to unscrew one screw of the license plate, slide the FM tag behind it, line-up the FM tag mounting hole, and put back the screw into the license plate. Alternatively, any invisible clipping techniques can also be used.

The antenna input in the FM tag can be conveniently coupled to the antenna formed by the license plate by capacitance coupling between the FM tag and the plate. A second capacitance coupling can take place between the plate and the car. Capacitance depends on the ratio of surface to spacing. The FM tag will have a small surface coupling limited to the tag size but will be less that 0.5 mm spacing. The plate will be at a greater distance from the car (i.e. truck or bumper metal structure) but will present a wider surface area. In this way, no electrical connections will need to be made between the tag and car at the time of installation.

1. A method of detecting a change in the configuration of an object, comprising:
forming an antenna from at least a portion of said object or providing an antenna closely electrically coupled to said object;
receiving remote radio transmissions with a radio receiver using said antenna; and
detecting a change in the configuration of said object by monitoring the signal strength of the radio transmissions received from said antenna.

2. A method as claimed in claim 1, wherein the object is a shipping container including doors, and the change in configuration corresponds to a door opening or closing event, and the body of the shipping container forms at least part of the antenna.

3. (canceled)

4. A method as claimed in claim 2, wherein the doors have a gap therebetween when closed, and said gap forms a slot such that the doors and gap together form a slotted antenna providing said antenna.

5. A method as claimed in claim 1, wherein the position of the object, upon detection of a change in configuration of the object, is derived from the signal strengths of radio frequency transmissions received from transmitters at known locations.

6. (canceled)

7. A method as claimed in claim 1, wherein the position of the object, upon detection of a change in configuration of the object, is determined by correlating the received radio frequency spectrum with stored radio frequency spectra for different locations.

8. A method as claimed in claim 1, wherein a leaky coaxial cable closely associated with the object forms at least part of the antenna, and wherein changes in configuration of the object result in changes in the signal strength of the transmission resulting from the leaky antenna.

9. A method of determining the position of an object, comprising:
receiving radio transmissions from a plurality of transmitters;
deriving the position of the object from the signal strengths of received radio transmissions; and
wherein the radio transmissions are received on an antenna constituted at least in part by the body of the object.

10. A method as claimed in claim 9, wherein the object is a shipping container, and the antenna is constituted at least in part by the doors of the container and a gap therebetween such that the doors and gap form a slotted antenna.

11. A method as claimed in claim 9 wherein the position of the object is derived by comparing the received signal strengths of said radio transmissions with a database of known transmitter characteristics.

12. A method as claimed in claim 9, wherein the position of the object is derived by correlating a received signal spectrum with stored radio frequency spectra for different locations.

13. (canceled)

14. A method as claimed in claim 9, wherein 3D acceleration data is used to wake the processor from a sleep mode to minimize the consumption of energy when the object is not in motion.

15. A method as claimed in claim 9, wherein 3D acceleration data is correlated with FM spectrum data to improve positional information.

16. A method as claimed in claim 9 wherein 3D information is used to identify the location of mishandling the object and amount of “g” and direction of impact of the said object.

17. An object monitoring apparatus, comprising:
a tag having an antenna input for receiving radio transmissions from an antenna and circuitry for detecting changes in signal strength of the received radio transmissions; and
an antenna adapted to be closely electrically coupled to said object or comprise at least a portion of said object whereby changes in configuration of the object can be detected from changes in signal strength of the received radio transmissions.

18. An object monitoring apparatus as claimed in claim 17, wherein said antenna forms part of the body of said object.

19. An object monitoring apparatus tag as claimed in claim 17, wherein said object is a shipping container, and the antenna is formed at least in part by the doors of the container and a gap therebetween, whereby the doors and gap together form a slotted antenna.

20. An object monitoring apparatus as claimed in claim 17, further comprising a second antenna mounted inside a door gasket and configured to communicate bi-directionally between the object and other external RF transceivers.

21. An object monitoring apparatus as claimed in claim 17, wherein the tag is configured to enter a low power sleep mode when the object is dormant, and an RF wake-up circuit is used to wake-up the tag when the object ceases to be dormant.

22. An object tracing tag, comprising:
an antenna input for receiving radio transmissions from an antenna;
a device for deriving the position of the object from received radio transmissions; and
wherein the antenna is constituted at least in part by the body of the object.

23. An object tracing tag as claimed in claim 22, wherein the object is a shipping container and the antenna is constituted at least in part by the doors of the container and a gap therebetween, whereby the doors and gap form a slotted antenna.

24. An object tracing tag as claimed in claim 22, wherein the object is a vehicle, and the antenna is formed by a gap between the license plate and vehicle body.

25. An object tracing tag as claimed in claim 24, wherein the tag is adapted to be covertly fitted behind the license plate.

26. An object tracing tag as claimed in claim 25, wherein the antenna input is coupled to the license plate antenna by capacitance coupling.

27. An object tracing tag as claimed in claim 23, further comprising a detector for detecting changes in configuration of the shipping container by detecting changes in signal strength of the received transmissions when the container changes configuration.

28. An object tracing tag as claimed in claim 17 further comprising a transceiver for communicating said positional information to an external receiver.

29. An object tracing tag as claimed in claim 28, further comprising a receiver responsive to a signal indicating the presence of said external receiver to wake up the transceiver from a sleep mode, whereby said transceiver communicates said positional information to said external receiver.

30. A method of detecting the breach in integrity of a metallic enclosure, comprising:
mounting a miniature antenna on the ceiling of the container;
connecting a monitoring tag for monitoring RF energy leaking into said metallic enclosure from an external source, and
detecting a breach in the integrity of said container from change in said RF energy leaking into said enclosure.

31. A method as claimed in claim 30, wherein said RF energy originates from an FM broadcast transmitter.

32. A method as claimed in claim, wherein the object is networked with other objects, and the status of the object is transmitted to other nearby objects.

33. (canceled)

34. A method of monitoring a vehicle, comprising:
fitting the vehicle with a tag capable of determining the position of the vehicle by trilateration of radio transmissions;
storing position data of the vehicle at intervals in memory; and
retrieving the position data of the vehicle to determine the route taken by the vehicle.

35. A method as claimed in claim 34, wherein the vehicle has a vehicle body forming an antenna for the tag.

36. A method as claimed in claim 35, wherein a gap between the trunk or hood of the vehicle and the rest of the vehicle body forms said antenna as a slotted antenna.

37. A method as claimed in claim 35, wherein a gap between the license plate of the vehicle and the rest of the vehicle body forms a patch antenna providing said antenna for the tag.

38. A method as claimed in claim 34, wherein upon in response to a signal emitted by a data receiver, the tag transmits the stored position data to the receiver.

39. A method as claimed in claim 34, wherein upon in response to a unique signal emitted by a data transceiver, the tag records the unique signal emitted by the transceiver.

40. (canceled)

41. A method of determining the position of an object, comprising:
receiving radio transmissions from a plurality of transmitters;
monitoring the position of the object with a satellite-based navigation system; and
deriving the position of the object from the signal strengths of received radio transmissions, the satellite-based navigation system, or a combination of the two.

42. A method as claimed in claim 41, wherein the relative contributions of the satellite-based navigation system and the radio-transmission based system to the position fixes is determined by power and/or signal strength availability.

43. A method as claimed in claim 41, comprising a plurality of said objects located in proximity to each other, and wherein said objects are arranged to form a wireless network, and wherein said objects exchange positional information on a peer-to-peer basis over said wireless network.

44. A method as claimed in claim 9, wherein said positional information derived from said radio transmissions uses course positional information derived from a satellite-based navigation system to improve trilateration calculation accuracy.

45. A method as claimed claim, wherein a satellite-based navigation system is monitored to provide an accurate time reference.

46. A method as claimed in claim 9 further comprising obtaining positional information from a satellite-based system to provide an initial reference point for the radio-transmission based system.
